(19) United States
(12) Patent Application Publication
(10) Pub. No.: US 2003/0076526 A1
(43) Pub. Date: Apr. 24, 2003

(54) Method and apparatus for printing documents using a document repository in a distributed data processing system

(75) Inventor: Prabhakar Gopalan, Austin, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY

(21) Appl. No.: 09/981,895

(22) Filed: Oct. 18, 2001

(51) Int. Cl. G06F 3/12; G06F 13/00; G06F 15/00

(52) U.S. Cl. 358/1.15; 358/1.16

(57) ABSTRACT

A method, apparatus, and computer instructions for managing a document. A request is received from a user at a remote data processing system to save a document for printing in which the request includes the document. The document is then stored in a repository in association with the user in response to receiving the request to form a stored document. The stored document is sent to a printer in response to a signal.

### BACKGROUND OF THE INVENTION

1. Technical Field

The present invention relates generally to an improved data processing system and in particular to a method and apparatus for managing documents. Still more particularly, the present invention provides a method, apparatus, and computer instructions for managing the printing of documents in a distributed data processing system.

2. Description of Related Art

The Internet, also referred to as an “internetwork”, is a set of computer networks, possibly dissimilar, joined together by means of gateways that handle data transfer and the conversion of messages from a protocol of the sending network to a protocol used by the receiving network. When capitalized, the term “Internet” refers to the collection of networks and gateways that use the TCP/IP suite of protocols.

The Internet has become a cultural fixture as a source of both information and entertainment. Many businesses are creating Internet sites as an integral part of their marketing efforts, informing consumers of the products or services offered by the business or providing other information seeking to engender brand loyalty. Many federal, state, and local government agencies are also employing Internet sites for informational purposes, particularly agencies which must interact with virtually all segments of society such as the Internal Revenue Service and secretaries of state. Providing informational guides and/or searchable databases of online public records may reduce operating costs.

Currently, the most commonly employed method of transferring data over the Internet is to employ the World Wide Web environment, also called simply “the Web”. Other Internet resources exist for transferring information, such as File Transfer Protocol (FTP) and Gopher, but have not achieved the popularity of the Web. In the Web environment, servers and clients effect data transaction using the Hypertext Transfer Protocol (HTTP), a known protocol for handling the transfer of various data files (e.g., text, still graphic images, audio, motion video, etc.). The information in various data files is formatted for presentation to a user by a standard page description language, the Hypertext Markup Language (HTML). In addition to basic presentation formatting, HTML allows developers to specify “links” to other Web resources identified by a Uniform Resource Locator (URL). A URL is a special syntax identifier defining a communications path to specific information. Each logical block of information accessible to a client, called a “page” or a “Web page”, is identified by a URL. The URL provides a universal, consistent method for finding and accessing this information, not necessarily for the user, but mostly for the user's Web “browser”. A browser is a program capable of submitting a request for information identified by an identifier, such as, for example, a URL. A user may enter a domain name through a graphical user interface (GUI) for the browser to access a source of content. The domain name is automatically converted to the Internet Protocol (IP) address by a domain name system (DNS), which is a service that translates the symbolic name entered by the user into an IP address by looking up the domain name in a database.

When viewing Web pages from different Web sites, a user may desire to print these documents, which include text and graphics. In some cases, the particular printer that a user desires to use may be unavailable. Specifically, the printer may be offline or busy with other print jobs. For example, if the Web page contains color graphics and the user desires to have a color output, the user may select a printer with color capabilities. This printer may be located in a remote location on a network. If the printer is offline, the user will be unable to obtain a color output. In this instance, the user is required to return to the desired page and print that page at a later time when the printer is online. The unavailability of a printer also may occur with respect to a word processing document generated by a user or an e-mail message.

Therefore, it would be advantageous to have an improved method, apparatus, and computer instructions for handling the printing of documents.

### SUMMARY OF THE INVENTION

The present invention provides a method, apparatus, and computer instructions for managing a document. A request is received from a user at a remote data processing system to save a document for printing in which the request includes the document. The document is then stored in a repository in association with the user in response to receiving the request to form a stored document. The stored document is sent to a printer in response to a signal.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram illustrating a data processing system in which the present invention may be implemented;

FIG. 4 is a diagram illustrating components used in managing the printing of items in accordance with a preferred embodiment of the present invention;

FIGS. 5A-5C are diagrams illustrating examples of records in accordance with a preferred embodiment of the present invention;

FIG. 6 is a diagram of a browser displayed in a data processing system in accordance with a preferred embodiment of the present invention;

FIG. 7 is a diagram of an access screen in accordance with a preferred embodiment of the present invention;

FIG. 8 is a flowchart of a process used for generating a record in accordance with a preferred embodiment of the present invention;

FIG. 9 is a flowchart of a process used for accessing a portable print queue in accordance with a preferred embodiment of the present invention;

FIG. 10 is a flowchart of a process used for storing records in a portable print queue in accordance with a preferred embodiment of the present invention; and

FIG. 11 is a flowchart of a process used for accessing and printing records in accordance with a preferred embodiment of the present invention.

### DETAILED DESCRIPTION OF THE PREFERRED EMBODIMENT

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. In this example, network data processing system 100 also includes printers 114, 116, and 118. Printer 114 is attached to server 104 while printer 118 is attached to client 108. Printer 116 is a network printer directly connected to network 102 in this example. Network data processing system 100 may include additional servers, clients, and other devices not shown. The present invention may be implemented in network data processing system 100 to manage the printing of documents on printers, such as printers 114, 116, and 118. Server 104 may serve as a portable print queue or a repository to store documents or other data to be printed in the event that a printer selected for printing a particular document is unavailable. This unavailability may be caused by the printer being offline or a printer queue being too long for a user to wait until the document is printed. The mechanism of the present invention allows a user at a client, such as client 112, to have data stored in a repository in server 104 for later printing. This mechanism will be described in more detail below.

In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

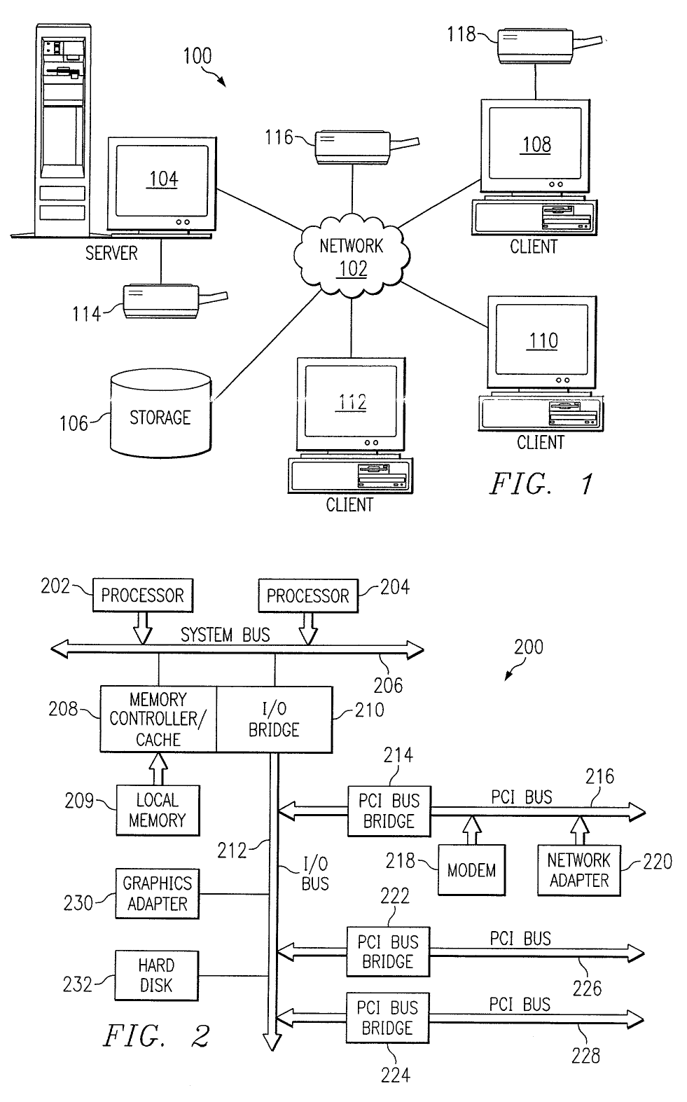

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, N.Y., running the Advanced Interactive Executive (AIX) operating system or LINUX operating system.

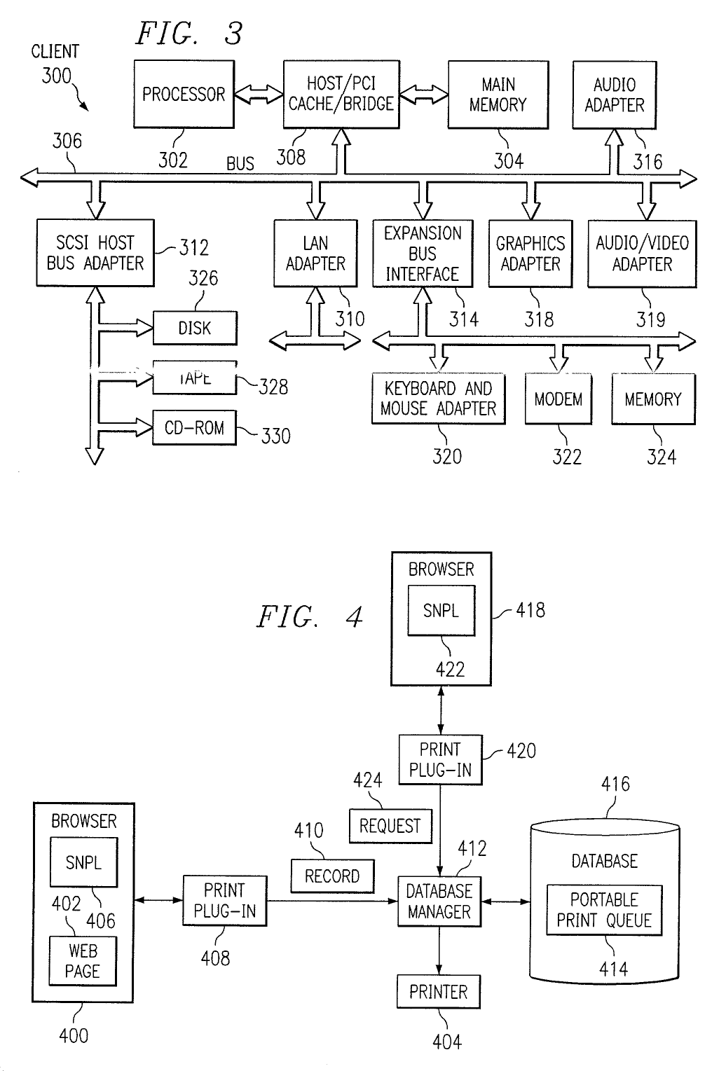

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

The present invention provides a method, apparatus, and computer instructions for managing printing of items, such as word processing documents, e-mail messages, or Web pages, when a printer is unavailable. In these examples, a Web based repository on a distributed data processing system, such as network data processing system 100 is provided to store either “bookmarked” pages or entire documents and allow for the printing of these items at a later time.

Turning next to FIG. 4, a diagram illustrating components used in managing the printing of items is depicted in accordance with a preferred embodiment of the present invention. In this example, a user using any desktop software may decide to print all or part of an item, such as a word processor document, an e-mail message, a Web page, or a spreadsheet. In this example, the software is browser 400 and the item is Web page 402. If the user finds that printer 404 is unavailable because printer 404 is offline or the printer queue for printer 404 is too long for the user to wait to have the document printed, the user may mark or save Web page 402 using “save now print later” (SNPL) icon 406 in browser 400. Manipulation of SNPL icon 406 activates print plug-in 408, which generates record 410 and sends it to database manager 412. A plug-in is an auxiliary program that works with a software package or application to enhance its capability. For example, plug-ins are widely used in image editing programs to add a filter for some special effect. Plug-ins are added to Web browsers to enable them to support new types of content. In this example, print plug-in 408 is a plug-in for a GUI based program, such as a word processor or a Web browser. This plug-in provides an icon, such as SNPL 406 within browser 400. Print plug-in 408 provides a mechanism for connecting to a remotely based persistent storage, such as a database. Database manager 412 stores record 410 in portable print queue 414 within database 416. Portable print queue 414 also is referred to as a “repository”. Portable print queue 414 may be transferred to a client at which the user is located. Further, portable print queue 414 may be initially established locally at the client and transferred to database 416 by the user.

In this example, browser 400 and print plug-in 408 are located in a client, such as client 112 in FIG. 1. Database manager 412 and database 416 are located in a server, such as server 104 in FIG. 1. Printer 404 may be a printer, such as printer 114, printer 116, or printer 118 in FIG. 1. Although database 416 is described as being located within server 104 in FIG. 1, this repository may be located elsewhere such as storage unit 106 in FIG. 1. Further, multiple databases in the same or different location also may be used depending on the particular implementation.

At a later time, the user may access records within database 416 from browser 418, which is located in another data processing system, such as client 110 in FIG. 1. In this example, browser 418 includes print plug-in 420, which provides SNPL icon 422. Access to these records is initiated through manipulation of SNPL icon 422 to generate request 424. Of course, the user could access these records from the same client through browser 400 depending on the location of the user. The user may send request 424 to database manager 412 to cause record 410 to be printed to printer 404. Request 424 causes record 410 to be retrieved from portable print queue 414 and sent to printer 404 for printing.

The access to these records may be controlled through presently available authentication mechanisms. Further, the mechanism of the present invention also allows for portable print queue 414 to be downloaded for local use. Depending on the particular implementation, portable print queue 414 may be located locally within the same client as the browser or other software being used by the user. In this case, the repository may be sent to database 416 when a connection is established by the print plug-in. This particular implementation allows for all records within the repository to be transferred to the database at one time reducing the number of connections established by the print plug-in.

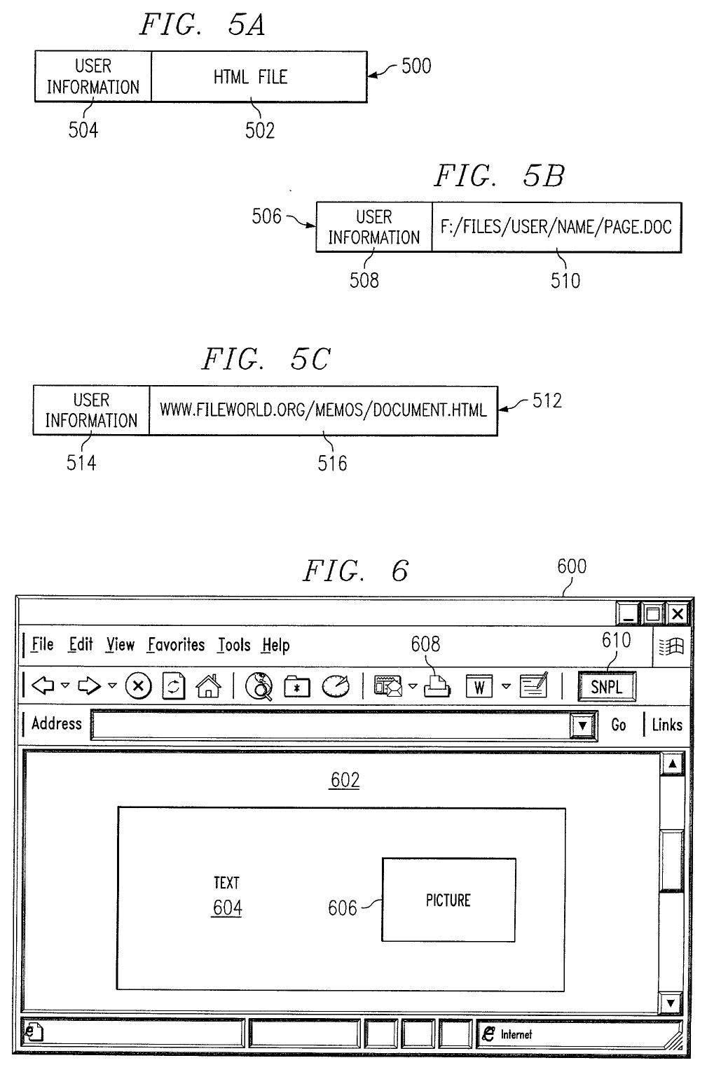

With reference next to FIGS. 5A-5C, diagrams illustrating examples of records are depicted in accordance with a preferred embodiment of the present invention. A user may decide to store only a pointer to the data or save the data. By only saving a pointer, the amount of file space is reduced while actually saving the data prevents an inability to print the data later in the event that the data is moved or deleted from the location associated with the pointer.

In FIG. 5A, record 500 contains the entire document or all of the data that is to be printed. In this example, the data or document is formatted as HTML document 502. User information 504 is used to associate record 500 with the user when record 500 is stored within a portable print queue, such as portable print queue 414 in database 416 in FIG. 4. Additionally, user information 504 also may include data for authenticating the user. In FIG. 5B, record 506 contains user information 508 and path 510. In this example, the record does not contain the data that is to be printed. Instead, a pointer to the data is employed. In FIG. 5C, record 512 includes user information 514 and universal resource locator (URL) 516. URL 516 serves as a pointer to the data in this particular example. When pointers are used, these pointers may be employed by the print plug-in or by the repository manager to retrieve the data for printing.

With respect to the format of data in a record, other information, such as date, time, file size, and location also may be stored within the record. This information may be stored in the form of information within an HTML file and include a link to the document, such as record 506 in FIG. 5B and record 512 in FIG. 5C. Alternatively, the HTML file may include the data to be printed, such as record 500 in FIG. 5A. If the document is, for example, a Web page, the picture format files also may be stored in the record in addition to the text. For example, a Joint Photographic Experts Group (JPEG) image is stored in a record along with the association to its location with respect to the text.

Turning next to FIG. 6, a diagram of a browser displayed in a data processing system is depicted in accordance with a preferred embodiment of the present invention. In this example, browser 600 displays Web page 602, which includes text 604 and picture 606. Browser 600 may be, for example, browser 400 in FIG. 4. If the user desires to print the document, the user may select print icon 608. If, however, the printer is unavailable, the user may manipulate SNPL icon 610 to have Web page 602 stored as a record for printing at a later time. In this example, the manipulation of SNPL icon 610 is a single click of a left mouse button. Of course, other types of user input may be used for this manipulation. The user may later then manipulate SNPL icon 610 with a different type of manipulation such as the right click of a mouse button to access the record containing Web page 602.

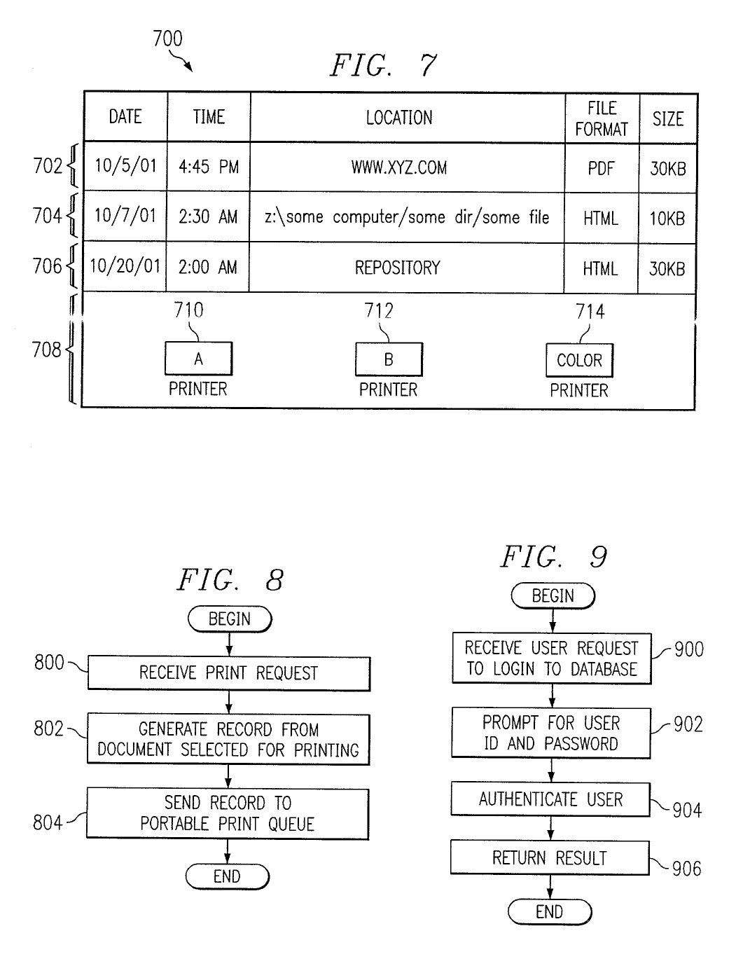

With reference next to FIG. 7, a diagram of an access screen is depicted in accordance with a preferred embodiment of the present invention. Access screen 700 is an example of an access screen that may be presented to a user in response to manipulation of an SNPL button, such as SNPL button 610 in FIG. 6. Access screen 700 is presented through a print plug-in, such as print plug-in 408 in FIG. 4. Access screen 700 includes rows 702, 704, and 706. These rows represent records stored in a repository associated with the user. Each row may include a date, time, location, file format, and size. Rows 702 and 704 illustrate records in which pointers are stored while row 706 illustrates a record in which the actual data is stored. The location of the data is indicated as the repository, identifying that the data is actually stored at the repository. The user may now select one or more of the records in access screen 700 for printing.

Additionally, access screen 700 also includes printer section 708. In this portion of access screen 700, printers 710, 712, and 714 are displayed for selection by a user. The user may select a record, such as record 702, and have that record sent to one of these printers for printing.

In setting up a print plug-in, such as print plug-in 408 in FIG. 4, the user may identify a location for the repository as being local or remote. If the portable print queue is to be remotely located, the user may enter a file transfer protocol (FTP) address of the server at which the portable print queue is to be located. Additionally, a user identification and a password also may be entered for authenticating access to the server.

With reference now to FIG. 8, a flowchart of a process used for generating a record is depicted in accordance with a preferred embodiment of the present invention. The process illustrated in FIG. 8 may be implemented in a print plug-in, such as print plug-in 408 in FIG. 4.

The process begins by receiving a print request (step 800). This print request is identified by a manipulation of a graphical image, such as SNPL icon 406 in FIG. 4. A record is generated from the document selected for printing (step 802). These records may be formatted in the manner described in FIGS. 5A-5C. The record is sent to a database for storage in a portable print queue (step 804) and the process terminates thereafter.

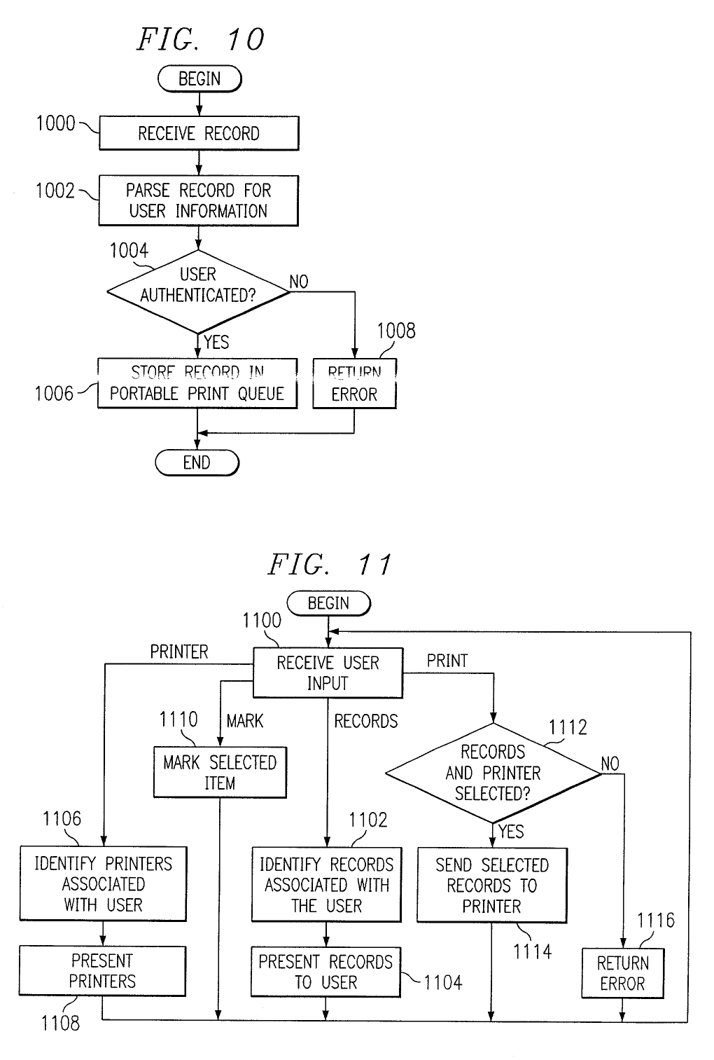

Turning now to FIG. 9, a flowchart of a process used for accessing a portable print queue is depicted in accordance with a preferred embodiment of the present invention. The process illustrated in FIG. 9 may be implemented in a portable database manager, such as database manager 412 in FIG. 4. This process may be implemented using presently available authentication mechanisms.

The process begins by receiving a user request to login to the repository (step 900). The user is prompted for user identification and a password (step 902). The user is authenticated (step 904). A result is returned (step 906) with the process terminating thereafter.

With reference now to FIG. 10, a flowchart of a process used for storing records in a portable print queue is depicted in accordance with a preferred embodiment of the present invention. The process illustrated in FIG. 10 may be implemented in a database manager and a database, such as database manager 412 and database 416 in FIG. 4. Of course, if the portable print queue is located locally, this process may be implemented by a print plug-in, such as print plug-in 408 in FIG. 4. This local portable print queue may then be transferred to database manager 412 or some other client at a later time.

The process begins by receiving a record (step 1000). In these examples, the record may be formatted in the manner described in FIGS. 5A-5C. The record is parsed for user information (step 1002). Next, a determination is made as to whether the user identified in the user information is authenticated (step 1004). If the user is authenticated, the record is stored in a portable print queue associated with the user (step 1006) and the process terminates thereafter.

Turning again to step 1004, if the user is not authenticated, an error is returned (step 1008) and the process terminates.

Turning now to FIG. 11, a flowchart of a process used for accessing and printing records is depicted in accordance with a preferred embodiment of the present invention. The process illustrated in FIG. 11 may be implemented in a print plug-in, such as print plug-in 408 in FIG. 4. Records may be displayed and printed using a screen, such as access screen 700 in FIG. 7.

The process begins by receiving a user input (step 1100). If the user input is a request for access to records, records associated with the user are identified (step 1102). Step 1102 may include searching a database for a portable print queue or repository associated with the user. Then, the identified records are presented to the user (step 1104) and the process returns to step 1100. These records may be presented to the user using access screen 700 in FIG. 7.

If the user input is a request for available printers, printers associated with the user are identified (step 1106). The printers are presented (step 1108) and the process returns to step 1100. These printers also may be presented using access screen 700 in FIG. 7.

A user may select items, such as a record or a printer from the information presented in these examples. If the user input is one selecting one or more items, selected items are marked (step 1110) and the process returns to step 1100.

If the user input received in step 1100 is to print, a determination is made as to whether one or more records and a printer have been selected (step 1112). If the records and printer have been selected, the selected records are sent to the printer (step 1114) with the process returning to step 1100.

If the records and printer are not selected, an error is returned (step 1116) and the process returns to step 1100.

Thus, the present invention provides an improved method, apparatus, and computer instructions for managing printing of documents. The mechanism of the present invention is especially advantageous when a printer is unavailable because the printer is offline or the printer queue is too long for the user to wait. The mechanism allows the user to mark or save their document for printing at a later time. The document or a pointer to the document is placed into a record, which is saved in a portable print queue. This portable print queue may be accessed from any client connected to a network data processing system. This mechanism may be used for various applications, including a Web based e-mail system. In this type of implementation, added convenience is provided to the user as well as a central point for managing documents.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. In the depicted examples, the processes of the present invention are implemented in a plug-in. Depending on the particular implementation, the processes described with respect to the plug-in may be implemented in other forms, such as a separate application or as additional code added to a current application. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for managing a document, the method comprising:
receiving a request from a user at a remote data processing system to save a document for printing, wherein the request includes the document;
storing the document in a repository in association with the user in response to receiving the request to form a stored document; and
sending the stored document to a printer in response to a signal.

2. The method of claim 1, wherein the printer is located at one of the remote data processing system or the data processing system.

3. The method of claim 1, wherein the step of storing the document comprises:
storing a pointer to the document.

4. The method of claim 1, wherein the pointer is one of a path or a universal resource locator.

5. The method of claim 2, wherein the step of sending the document comprises:
retrieving the document using the pointer to form a retrieved document; and
sending the retrieved document to the printer.

6. The method of claim 1 further comprising:
responsive to a request from the user to access the repository, sending an identification of all documents associated with the user to the user at the remote data processing system.

7. A method in a data processing system for managing printing of a document, the method comprising:
responsive to a manipulation of a selected graphical indicator, saving a document associated with the graphical indicator in a repository for printing at a later time; and
responsive to a request to print the document stored in the repository, sending the request to the repository, wherein the document is sent to a printer for printing.

8. The method of claim 7 further comprising:
requesting an identification of documents in the repository in response to a request for access to the repository; and
displaying documents stored in the repository in response to receiving the identification.

9. The method of claim 7, wherein the repository holds documents for a plurality of different users.

10. The method of claim 7, wherein the printer is located at the repository.

11. The method of claim 7, wherein the printer is located at another data processing system.

12. The method of claim 8, wherein the request to access the document is generated by a second manipulation of the graphical indicator.

13. The method of claim 7, wherein the sending step and the saving step are performed by a print plug-in.

14. A data processing system comprising:
a bus system;
a communications unit connected to the bus system;
a memory connected to the bus system, wherein the memory includes a set of instructions; and
a processing unit connected to the bus system, wherein the processing unit executes the set of instructions to receive a request from a user at a remote data processing system to save a document for printing in which the request includes the document; store the document in a repository in association with the user in response to receiving the request in which the document forms a stored document; and send the stored document to a printer in response to a signal.

15. A data processing system comprising:
a bus system;
a communications unit connected to the bus system;
a memory connected to the bus system, wherein the memory includes a set of instructions; and
a processing unit connected to the bus system, wherein the processing unit executes the set of instructions to save a document associated with the graphical indicator in a repository for printing at a later time in response to a manipulation of a selected graphical indicator; and send the request to the repository in which the document is sent to a printer for printing in response to a request to print the document stored in the repository.

16. A data processing system for managing a document, the data processing system comprising:
receiving means for receiving a request from a user at a remote data processing system to save a document for printing, wherein the request includes the document;
storing means for storing the document in a repository in association with the user in response to receiving the request to form a stored document; and
sending means for sending the stored document to a printer in response to a signal.

17. The data processing system of claim 16, wherein the printer is located at one of the remote data processing system or the data processing system.

18. The data processing system of claim 16, wherein the storing means comprises:
means for storing a pointer to the document.

19. The data processing system of claim 16, wherein the pointer is one of a path or a universal resource locator.

20. The data processing system of claim 17, wherein the sending means comprises:
retrieving means for retrieving the document using the pointer to form a retrieved document; and
sending means for sending the retrieved document to the printer.

21. The data processing system of claim 16, wherein the sending means is a first sending means and further comprising:
second sending means, responsive to a request from the user to access the repository, for sending an identification of all documents associated with the user to the user at the remote data processing system.

22. A data processing system for managing printing of a document, the data processing system comprising:
saving means, responsive to a manipulation of a selected graphical indicator, for saving a document associated with the graphical indicator in a repository for printing at a later time; and
sending means, responsive to a request to print the document stored in the repository, for sending the request to the repository, wherein the document is sent to a printer for printing.

23. The data processing system of claim 22 further comprising:
requesting means for requesting an identification of documents in the repository in response to a request for access to the repository; and
displaying means for displaying documents stored in the repository in response to receiving the identification.

24. The data processing system of claim 22, wherein the repository holds documents for a plurality of different users.

25. The data processing system of claim 22, wherein the printer is located at the repository.

26. The data processing system of claim 22, wherein the printer is located at another data processing system.

27. The data processing system of claim 23, wherein the request to access the document is generated by a second manipulation of the graphical indicator.

28. The data processing system of claim 22, wherein the sending means and the saving means are located in a print plug-in.

29. A computer program product in a computer readable medium for managing a document, the computer program product comprising:
first instructions for receiving a request from a user at a remote data processing system to save a document for printing, wherein the request includes the document;
second instructions for storing the document in a repository in association with the user in response to receiving the request to form a stored document; and
third instructions for sending the stored document to a printer in response to a signal.

30. A computer program product in a computer readable medium for managing printing of a document, the computer program product comprising:
first instructions, responsive to a manipulation of a selected graphical indicator, for saving a document associated with the graphical indicator in a repository for printing at a later time; and
second instructions, responsive to a request to print the document stored in the repository, for sending the request to the repository, wherein the document is sent to a printer for printing.
